(19) United States
(12) Patent Application Publication
(10) Pub. No.: US 2025/0362157 A1
(43) Pub. Date: Nov. 27, 2025

(54) Swivel Angle Measuring Device on a Hydrostatic Axial Piston Machine with Variable Stroke Volume

(71) Applicant: Robert Bosch GmbH, Stuttgart (DE)

(72) Inventors: Tobias Loeffler, Pliezhausen (DE); Andre Yashan, Stuttgart (DE); David Haenle, Neu-Ulm (DE); Hubert Stratmann, Roggenburg (DE); Jan Beyersdorfer, Gerstungen (DE); Jochen Kircher, Ulm (DE); Steffen Raschendorfer, Bibertal (DE); Thomas Ullmann, Arnstadt (DE); Vaclav Pikhart, Straz nad Nezarkou (CZ)

(21) Appl. No.: 19/211,944

(22) Filed: May 19, 2025

(30) Foreign Application Priority Data
May 23, 2024 (DE) 10 2024 204 743.0

(51) Int. Cl. G01D 5/14; F15B 15/14; F15B 19/00

(52) U.S. Cl. CPC G01D 5/145; F15B 15/1447; F15B 19/00; G01D 2205/24

(57) ABSTRACT

A swivel angle measuring device is configured to indirectly sense a swivel angle of a swashplate or cylinder drum of an axial piston machine. The swivel angle is adjustable using an adjustment piston guided in an adjustment cylinder. The swivel angle measuring device includes a movable encoder and a transducer affixed to a housing. The encoder is formed by two permanent magnets that are carried linearly and translationally by the adjustment piston along its direction of movement and that have a distance to one other.

This application claims priority under 35 U.S.C. § 119 to patent application no. DE 10 2024 204 743.0, filed on May 23, 2024 in Germany, the disclosure of which is incorporated herein by reference in its entirety.

The disclosure relates to the detection of the swivel angle of a hydrostatic piston machine with adjustable stroke volume in a swashplate design or in an inclined axis design.

### BACKGROUND

From the prior art, hydrostatic axial piston machines with adjustable stroke volume in a swashplate design are known, the working pistons of which are coupled to a swashplate that is formed on a swivel cradle. In order to be able to adjust the stroke volume of the axial piston machine, the swivel cradle is pivotally mounted in the housing of the axial piston machine.

DE 10 2017 213 457 A1 shows such an axial piston machine, the swivel cradle of which is coupled to an adjustment piston of a hydrostatic adjustment device via a pivot formed with the swivel cradle in one piece and via a sliding block rotatably mounted thereon. The adjustment device has an adjustment cylinder configured as a screw-in installation sleeve in which the adjustment piston is accommodated in sections. The adjustment piston is double acting. The adjustment pressure means is provided by an external adjustment pressure means source.

In such axial piston machines, it is important to detect the swivel angle of the swivel cradle or the cylinder drum for the control and regulation tasks.

Rotary swivel angle measuring devices are known from the prior art.

DE10 2014 200 566 A1 discloses a rotary swivel angle measuring device positioned on the (non-physical) swivel axis of the swivel cradle. Thus, the swivel angle is sensed directly and without change (without overspeed or reduction). The swivel angle measuring device has a shaft coupled to the swivel cradle via a rotary coupling device and a swivel cradle pin. The coupling device is a leaf spring made of spring steel. The disadvantage of such swivel angle measuring devices is the design space requirement.

DE 10 2010 045 540 A1 discloses an axial piston machine, the adjustment device of which comprises an adjustment piston to which a rotary swivel angle measuring device is coupled. This has a permanent magnet which is moved along a circular path past a swivel angle transducer having a Hall sensor using a return lever. The return lever engages with its (free) end section in a receptacle of the adjustment piston.

Furthermore, it is known from in-house prior art to have the (free) end section of the return lever engage with the circumferential groove of the adjustment piston in the aforementioned axial piston machines with an adjustment piston and with a rotary swivel angle measuring device, in which the lever of the swivel cradle also engages. The swivel angle measuring device is inserted into a through-recess of the housing and thus seals the internal space of the axial piston machine in which tank pressure prevails.

The disadvantage of the latter two rotary swivel angle measuring devices and their transmission of a linear/translational adjustment piston movement into a rotary encoder movement is that the (free) end section of the return lever must always be moved in and out radially to the recess of the adjustment piston. In addition, the transmission of a comparatively wide movement of the adjustment piston (with increasing tendency) can only be converted into small rotational movements of the encoder at the end areas of the adjustment piston travel, wherein there is an increased risk of jamming. Furthermore, it is disadvantageous that the bearing of the return lever and the holder of the encoder magnet require increased design space in the axial direction of the bearing.

From the prior art, axial piston machines in an inclined axis design are also known, the adjustment cylinder of which is configured as a differential cylinder, to the piston rod of which a pin is attached extending transversely to the direction of travel of the adjustment piston, which carries a control lens. An end section of the piston rod extends into a measurement chamber and has an oblique groove, through which rotational swivel angle detection is carried out.

Furthermore, from the in-house, subsequently published prior art, a translational swivel angle measuring device with a rod magnet is known, which is carried by a swashplate-type adjustment piston of an axial piston machine.

### SUMMARY

The object of the disclosure is to avoid the disadvantages of rotary swivel angle detection and to continue to renew the subsequently-published prior art with translational swivel angle measuring device in which the measuring range of the swivel angle measuring device is to be increased.

The object is solved by a swivel angle measuring device, as disclosed herein, and by an axial piston machine, as disclosed herein.

The swivel angle measuring device is designed and configured to indirectly detect a swivel angle of a swashplate or cylinder drum of a hydrostatic axial piston machine. The swivel angle is adjustable by means of an adjustment piston guided in an adjustment cylinder, on which the indirect detection of the swivel angle takes place. For this purpose, the swivel angle measuring device has an encoder movable with the adjustment piston and a transducer affixed to the housing, in particular a Hall sensor. The swivel angle measuring device is translational. According to the disclosure, the encoder is coupled directly or indirectly to the adjustment piston and can be carried translationally along the direction of movement thereof. The encoder is formed by two preferably rod-shaped permanent magnets having a distance from each other.

This avoids the radial movement of the (free) end section of the return lever into and out of the recess/groove of the adjustment piston, which is necessary with the rotary swivel angle measuring device of the prior art. In particular, the transmission of a comparatively wide movement of the adjustment piston can be converted into an undiminished wide translational or linear movement of the encoder at the end areas of the adjustment piston travel, wherein the risk of jamming remains low. The measuring range may, for example, also be increased by 60 mm.

In a first principle of the swivel angle measuring device, as disclosed herein, the encoder is a four-pole encoder. To this end, the two north poles and the two south poles of the two permanent magnets are arranged along the direction of movement of the adjustment piston in an alternating sequence. More specifically, either first the north pole and then the south pole of the first permanent magnet and then the north pole and then the south pole of the second permanent magnet, correspondingly, are arranged in a row, or first the south pole and then the north pole of the first permanent magnet and then first the south pole and then the north pole of the second permanent magnet, correspondingly, are arranged in a row.

In a second principle of the swivel angle measuring device, as disclosed herein, the encoder is a three-pole encoder. To this end, either the two north poles or the two south poles of the two permanent magnets are assigned to each other along the direction of movement of the adjustment piston. More specifically, either first the north pole and then the south pole of the first permanent magnet and then the south pole and then the north pole of the second permanent magnet are arranged along the direction of movement of the adjustment piston, or first the south pole and then the north pole of the first permanent magnet and then the north pole and then the south pole of the second permanent magnet are arranged in a row.

Each permanent magnet has a major axis extending through the south pole and through the north pole of the respective permanent magnet. In a third principle of the swivel angle measuring device, as disclosed herein, the two major axes of the two permanent magnets are arranged perpendicular to the direction of movement of the adjustment piston. In this case, the north pole of the first permanent magnet and the south pole of the second permanent magnet face the transducer, while the south pole of the first permanent magnet and the north pole of the second permanent magnet face away from the transducer. Or, the south pole of the first permanent magnet and the north pole of the second permanent magnet face the transducer, while the north pole of the first permanent magnet and the south pole of the second permanent magnet face away from the transducer.

In one particularly flexible configuration of the swivel angle measuring device, as disclosed herein, the transducer can detect all possible movement directions of the permanent magnets in an adjacent plane of motion. This is referred to as a 3D sensor.

The transducer has an electronic sensor component that is stationary and affixed to the housing adjacent to the translationally moved permanent magnets. The sensor component has a longitudinal axis defining a major axis of the transducer. This major axis of the transducer may be arranged transversely or longitudinally to the direction of movement of the adjustment piston when using the 3D sensors mentioned above.

An air gap is provided between the permanent magnets and the sensor. A ratio of the air gap to the distance between the two permanent magnets is preferably between 0.295 and 0.558, in particular 0.426. For example, in a specific application, the air gap may be 4.35 mm while the distance between the two permanent magnets is 10.2 mm.

The disclosed hydrostatic axial piston machine has a swashplate or inclined axis design, and therefore has a swashplate or cylinder drum, the swivel angle of which can be adjusted by means of an adjustment piston guided in an adjustment cylinder. A swivel angle measuring device such as the one described above is in operative connection with the adjustment piston.

In one configuration, the adjustment cylinder is a differential cylinder, wherein the adjustment piston has a piston rod to which a transverse pin is attached. The two permanent magnets are then attached indirectly or directly to the end section of the piston rod opposite the piston. This end section is movable in a measuring housing in which the recipient is inserted (e.g., into a through-hole).

Preferably, the two permanent magnets are indirectly attached to the end section of the piston rod via a carrier component that extends along the direction of movement. The carrier component may be U-shaped when viewed in a sectional plane arranged transversely to the direction of movement of the adjustment piston. The carrier component may be a sheet metal bent part.

The two permanent magnets may be mounted in a magnetic housing attached to the carrier component.

### BRIEF DESCRIPTION OF THE FIGURES

Principles and exemplary embodiments of the disclosure will be described in the following on the basis of the accompanying figures.

FIG. 1 shows the exemplary embodiment of the axial piston machine, as disclosed herein, with a swivel angle measuring device, as disclosed herein;

FIG. 2 shows an excerpt of the axial piston machine of FIG. 1 with the swivel angle measuring device of FIG. 1;

FIG. 3 shows an excerpt of the axial piston machine of FIG. 1 with a second exemplary embodiment of the swivel angle measuring device as disclosed herein;

FIG. 4 shows an excerpt of the axial piston machine of FIG. 1 with a third exemplary embodiment of the swivel angle measuring device as disclosed herein;

FIG. 5 shows a fourth exemplary embodiment of the swivel angle measuring device as disclosed herein;

FIG. 6 shows a fifth exemplary embodiment of the swivel angle measuring device as disclosed herein; and

FIG. 7 shows a sixth exemplary embodiment of the swivel angle measuring device as disclosed herein.

### DETAILED DESCRIPTION

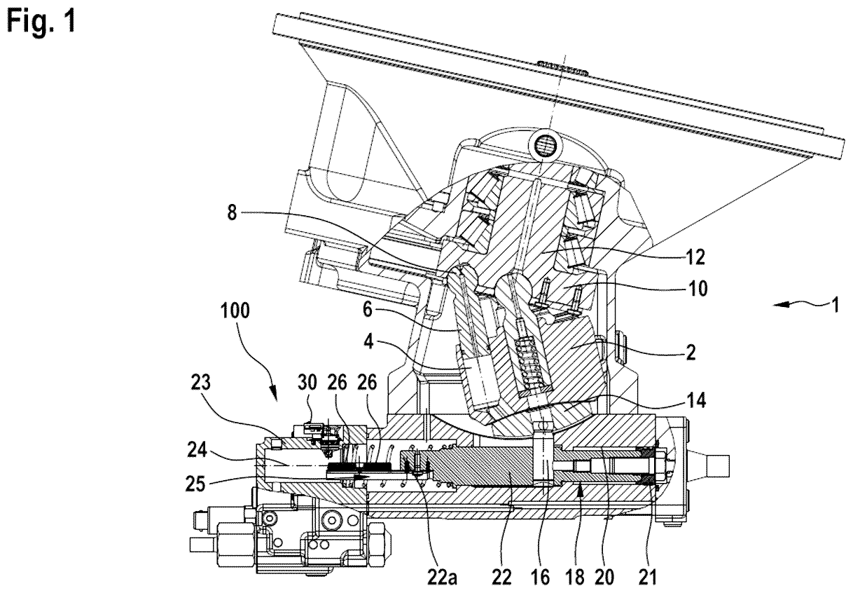

FIG. 1 shows an exemplary embodiment of the axial piston machine 1 according to the disclosure in a longitudinal section. It has a circumferential cylinder drum 2 at the circumference of which a plurality of cylinders 4 are formed, in each of which a piston 6 is arranged, respectively. Piston feet 8 of pistons 6 are flexibly coupled to a flange 10 of a drive shaft 12. According to the design principle of the inclined axle machine, a center axis of the cylinder drum 2 is inclined towards a center axis of the drive shaft 12.

In order to be able to change the inclined positions of the two center axes with respect to each other and thus the swivel angle of the cylinder drum 2, the latter has a concave abutment surface that is tensioned against a corresponding convex abutment surface of a control lens 14. Centrally engaged with the control lens 14 is a transverse pin 16 radially inserted into an adjustment piston 18. The adjustment piston 18 is guided in an adjustment cylinder 20 of an adjustment device along a direction of movement 24. The adjustment cylinder 20 is embodied as a double acting differential cylinder. Accordingly, the adjustment piston 18 is composed of a piston section 21 and a piston rod 22, from which the transverse pin 16 projects radially towards the control lens 14.

A central axis 24 of the piston rod 22 and thus also of adjustment cylinder 20 defines the direction of movement 24, wherein in FIG. 1, a movement to the left corresponds to a reduction of the swivel angle and thus a reduction of the stroke volume of axial piston machine 1, while a movement to the right corresponds to an increase of the swivel angle and thus an increase of the stroke volume of the axial piston machine 1.

A first exemplary embodiment of the swivel angle measuring device 100 according to the disclosure is disposed on a free end section 22a of the piston rod 22. It has a U-shaped carrier component 25 made of sheet metal, which extends into a measuring housing 23 parallel to the central axis 24. The carrier component 25 is fixed to the free end section 22a of the piston rod 22 by means of two pins and a screw. It carries two rod-shaped permanent magnets 26. More specifically, the two permanent magnets 26 are inserted or injected into a trough-like magnetic housing 28, which is attached to a central base side of the U-shaped carrier component 25. Two legs, of which only one leg is shown in FIG. 1 due to the section, extend (in FIG. 1 downwards) away from the permanent magnets 26 and their magnetic housing 28.

As already stated, the carrier component 25 extends with the magnetic housing 28 attached thereto and the two permanent magnets 26 mounted therein into the stationary measuring housing 23. At the maximum swivel angle of the axial piston machine 1 shown in FIG. 1, only the first permanent magnet 26 and a part of the second permanent magnet 26 are disposed in this measuring housing 23. At a minimum swivel angle, both permanent magnets 26 are disposed entirely in this measuring housing 23.

In a through-hole recess of the stationary measuring housing 23, a transducer 30, configured as a Hall sensor, is arranged, having a socket which is accessible on the outer side of the measuring housing 23.

FIGS. 2 to 4 each show the same section of the measuring housing 23 with three different exemplary embodiments of the swivel angle measuring device 100; 200; 300, as disclosed herein.

An electronic sensor component, which is housed in this end section of the transducer 30 and is therefore not visible, is mounted in an end section of the transducer 30 facing the permanent magnet 26 (shown as lower in FIGS. 2 to 4) and projecting into the measuring housing 23. In the exemplary embodiments shown in FIGS. 2 to 4, the axis of this sensor component and thus also a major axis 30b of the end section of the transducer 30 are arranged perpendicular to the drawing plane and thus transversely to the direction of movement 24 of the adjustment piston 18.

In the exemplary embodiment according to FIGS. 1 and 2, the rod-shaped permanent magnets 26 are disposed such that first a south pole S of the first permanent magnet 26, then its north pole N, then the south pole S of the second permanent magnet 26 and finally its north pole N are arranged along the direction of movement 24. A four-pole arrangement is thus formed from the two permanent magnets 26.

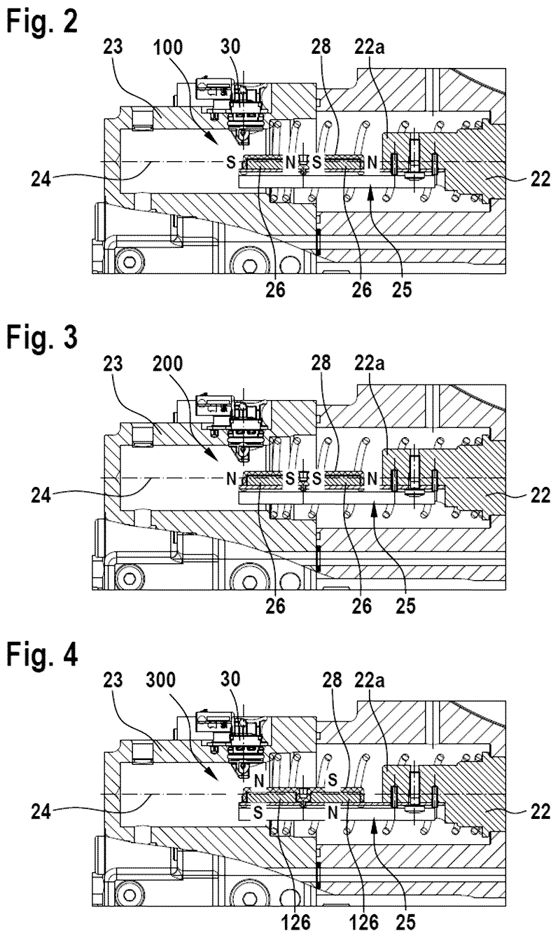

In the exemplary embodiment according to FIG. 3, the two rod-shaped permanent magnets 26 are arranged such that first a north pole N of the first permanent magnet 26, then its south pole S, then the south pole S of the second permanent magnet 26 and finally its north pole N are arranged along the direction of movement 24. A three-pole arrangement is thus formed from the two permanent magnets 26.

In the exemplary embodiment according to FIG. 4, the permanent magnets 126 are configured such that they have the two poles N, S on their long opposing sides. The first permanent magnet 126 has its north pole N on the side facing the transducer 30, while its south pole S faces the carrier component 25. Conversely, the second permanent magnet 126 has its south pole S on the side facing the transducer 30, while its north pole N faces the carrier component 25.

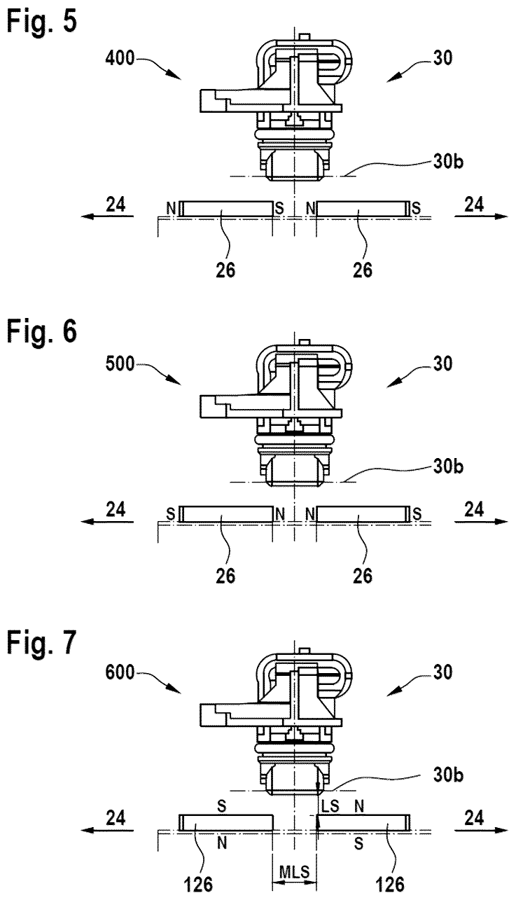

FIGS. 5 to 7 show a further exemplary embodiment of the swivel angle measuring device 200; 300; 400, as disclosed herein.

As already stated with reference to FIGS. 1 to 4, an electronic sensor component is mounted in the end section of the transducer 30 facing the permanent magnet 26 (shown as lower in FIGS. 5 to 7). The axis of this sensor component and thus also the major axis 30b of the end section of the transducer 30 is arranged parallel to the drawing plane and thus parallel to the direction of movement 24 in the exemplary embodiments shown in FIGS. 5 to 7.

In the exemplary embodiment according to FIG. 5, the rod-shaped permanent magnets 26 are arranged such that first a south pole S of the first permanent magnet 26, then its north pole N, then the south pole S of the second permanent magnet 26 and finally its north pole N are arranged along the direction of movement 24. A four-pole arrangement is thus formed from the two permanent magnets 26.

In the exemplary embodiment according to FIG. 6, the rod-shaped permanent magnets 26 are arranged such that first a north pole N of the first permanent magnet 26, then its south pole S, then the south pole S of the second permanent magnet 26 and finally its north pole N are arranged along the direction of movement 24. A three-pole arrangement is thus formed from the two permanent magnets 26.

In the exemplary embodiment according to FIG. 7, the permanent magnets 126 are configured such that they have the two poles N, S on their long opposing sides. The first permanent magnet 126 has its south pole S on the side facing the transducer 30, while its north pole N faces the carrier component 25. Conversely, the second permanent magnet 126 has its north pole N on the side facing the transducer 30, while its south pole S faces the carrier component 25.

The distance MLS between the two permanent magnets 26 may be 10.2 mm. The air gap AG between the end section of the transducer 30 configured as a Hall sensor and the permanent magnet 26 may be 4.35 mm+/−1.34 mm.

The two permanent magnets 26; 126 may be spaced apart from one another and the transducer 30 arranged such that the detectable range of motion of the adjustment piston 18 is 60 mm.

In the drawings FIG. 1 as well as FIG. 2 to FIG. 4, the arrangement of the sensor 30 to the two magnets 26 is shown in an orientation rotated by 90° compared to the illustration in FIG. 5 to FIG. 7. Any spatial installation location between the sensor 30 and the magnets 26 may be selected as long as the magnets 26 execute a recurring defined direction of movement along the major axis. In other words: Any spatial installation location between the sensor 30 and the magnets 26 may be selected as long as the magnets 26 perform a recurring defined movement along their direction of movement 24 (center axis 24) relative to the major axis 30b of the sensor 30.

### LIST OF REFERENCE NUMBERS

1 Axial piston machine
2 Cylinder drum
3 Cylinder
4 Piston
8 Piston foot
10 Flange
12 Drive shaft
14 Control lens
16 Transverse pin
18 Adjustment piston
20 Adjustment cylinder
21 Piston section
22 Piston rod
22a Free end section
23 Measuring housing
24 Center axis/direction of movement
25 Carrier component
26 Permanent magnet
28 Magnet housing
30 Transducer
30b Major axis
100 Swivel angle measuring device
126 Permanent magnet
200 Swivel angle measuring device
300 Swivel angle measuring device
400 Swivel angle measuring device
500 Swivel angle measuring device
600 Swivel angle measuring device
AG Air gap
MLS Distance

What is claimed is:

1. A swivel angle measuring device configured for indirectly sensing a swivel angle of a swashplate or a cylinder drum of a hydrostatic axial piston machine, the swivel angle is adjustable by an adjustment piston guided in an adjustment cylinder, the swivel angle measuring device comprising:
a movable encoder; and
a transducer affixed to a housing of the hydrostatic axial piston machine,
wherein the swivel angle measuring device is translational,
wherein the movable encoder is formed by two permanent magnets carried in a linear and translational manner by the adjustment piston along a direction of movement of the adjustment piston, and
wherein the two permanent magnets have a distance to each other.

2. The swivel angle measuring device according to claim 1, wherein:
each permanent magnet of the two permanent magnets has a corresponding north pole and a corresponding south pole, and
the two north poles and the two south poles of the two permanent magnets are arranged along the direction of movement of the adjustment piston in alternating order.

3. The swivel angle measuring device according to claim 1, wherein:
each permanent magnet of the two permanent magnets has a corresponding north pole and a corresponding south pole, and
either the two north poles or the two south poles of the two permanent magnets are assigned to each other along the direction of movement of the adjustment piston.

4. The swivel angle measuring device according to claim 1, wherein:
each permanent magnet of the two permanent magnets has a corresponding north pole and a corresponding south pole,
each permanent magnet has a major axis extending through the south pole and through the north pole,
the two major axes of the two permanent magnets are arranged perpendicular to the direction of movement of the adjustment piston, and
(i) the north pole of a first permanent magnet of the two permanent magnets and the south pole of a second permanent magnet of the two permanent magnets face the transducer, and the south pole of the first permanent magnet and the north pole of the second permanent magnet face away from the transducer, or (ii) the south pole of the first permanent magnet and the north pole of the second permanent magnet face the transducer, and the north pole of the first permanent magnet and the south pole of the second permanent magnet face away from the transducer.

5. The swivel angle measuring device according to claim 1, wherein the transducer is configured to sense all possible directions of movement of the two permanent magnets in a plane of motion.

6. The swivel angle measuring device according to claim 5, wherein:
the transducer has an electronic sensor component having a longitudinal axis defining a major axis of the transducer, and
the major axis of the transducer is disposed transversely or longitudinally to the direction of movement of the adjustment piston.

7. The swivel angle measuring device according to claim 6, wherein:
an air gap is provided between the two permanent magnets and the electronic sensor component, and
a ratio of the air gap to the distance of the two permanent magnets is between 0.295 and 0.558.

8. A hydrostatic axial piston machine in a swashplate or inclined axle design, comprising:
an adjustment piston guided in an adjustment cylinder and configured to adjust a swivel angle of a swashplate or cylinder drum; and
a swivel angle measuring device according to claim 1.

9. The hydrostatic axial piston machine according to claim 8, wherein:
the adjustment cylinder is a differential cylinder,
the adjustment piston has a piston rod,
a transverse pin is attached to the piston rod, and
the two permanent magnets are indirectly or directly attached to an end section of the piston rod.

10. The hydrostatic axial piston machine according to claim 9, wherein the two permanent magnets are indirectly attached via a carrier component to the end section of the piston rod extending along the direction of movement.

11. The hydrostatic axial piston machine according to claim 10, wherein the carrier component is U-shaped when viewed in a sectional plane arranged transversely to the direction of movement of the adjustment piston.

12. The hydrostatic axial piston machine according to claim 11, wherein the two permanent magnets are mounted in a magnetic housing fixed to the carrier component.
